(19) United States
(12) Patent Application Publication
(10) Pub. No.: US 2019/0214816 A1
(43) Pub. Date: Jul. 11, 2019

(54) Arrangement for Diverting Voltage Surges

(71) Applicant: EPCOS AG, München (DE)

(72) Inventors: Eduard Dorsch, Dallgow (DE); Frank Werner, Berlin (DE)

(21) Appl. No.: 16/071,194

(22) PCT Filed: Nov. 30, 2016
(86) PCT No.: PCT/EP2016/079326

§ 371 Date: Jul. 19, 2018

(30) Foreign Application Priority Data
Jan. 29, 2016 (DE) 102016101633.0

(51) Int. Cl. H02H 9/06; H02H 9/04

(52) U.S. Cl. CPC H02H 9/06; H02H 9/044

(57) ABSTRACT

An arrangement for diverting voltage surges is disclosed. In an embodiment an arrangement for arresting overvoltages includes a series circuit including a plurality of gas-filled surge arresters between a first potential node and a reference-ground potential node and at least one RC element comprising a capacitor and a resistor connected in parallel, the RC element being coupled from at least one potential node between the surge arresters directly to the reference-ground potential node.

This patent application is a national phase filing under section 371 of PCT/EP2016/079326, filed Nov. 30, 2016, which claims the priority of German patent application 10 2016 101 633.0, filed Jan. 29, 2016, each of which is incorporated herein by reference in its entirety.

### TECHNICAL FIELD

An arrangement for arresting overvoltages is described. The use of the arrangement in an electronic device or in an electrical grid is also described.

### BACKGROUND

A surge arrester serves to limit dangerous or undesirable overvoltages in electrical lines or devices. This can prevent damage to the lines and devices caused by overvoltages. Gas-filled surge arresters, which are also referred to as gas arresters, are surge arresters in which the overvoltage in the gas arrester is reduced as a result of the automatic ignition of a gas discharge. Said gas-filled surge arresters function according to the gas-physical principle of arc discharge, wherein, upon reaching an arrester response voltage, referred to as response voltage or as ignition voltage for short, an arc is formed in the gas-tight discharge chamber within nanoseconds. The overvoltage is effectively short-circuited as a result of the high current-carrying capacity of the arc.

In the event of static or stationary loading with an increase in the voltage of 100 V/s, the ignition voltage is referred to as DC response voltage U_{ag} and, in the event of dynamic loading with an increase in the voltage of 1 kV/μs, is referred to as response surge voltage Uₐₛ.

However, in the case of DC voltage, the arc and the associated flow of current are not extinguished when the voltage falls back below the overvoltage. This is only the case after the voltage falls below the arc burning voltage of the gas arrester, said arc burning voltage counteracting the applied DC voltage. When the voltage is below the arc burning voltage, the arc is quenched automatically. In order to increase the voltage at which the arc in an overvoltage protection device goes out, a plurality of gas arresters can be connected in series so that the arc burning voltages thereof are added together. However, this also increases the ignition voltage, which is required to ignite all the gas arresters.

The ignition voltage at which the gas arresters of a series circuit of N gas arresters ignite is approximately N times the ignition voltage of a gas arrester multiplied by 0.7. This has the effect that the protection level of such a series circuit is correspondingly high. However, the aim is an arrangement having the lowest possible ignition voltage or the lowest possible ignition value, in the ideal case the ignition voltage of a single gas arrester.

In order to reduce the ignition value, previous approaches have connected each gas arrester to a capacitor, for example, so that the increasing pulse voltage is dynamically applied to each gas arrester gradually.

### SUMMARY OF THE INVENTION

Embodiments provide an arrangement for arresting overvoltages that has improved properties. Further embodiments provide an arrangement for arresting overvoltages that has a constantly low response surge voltage as well as a use for it.

According to one aspect, an arrangement for arresting overvoltages is described. The arrangement has a series circuit composed of a plurality of gas-filled surge arresters between a first potential node and a reference-ground potential node. The arrangement can have, for example, four, five, ten or 20 gas-filled surge arresters (gas arresters). The arrangement is preferably a multiple gas arrester or multiple stack arrester. The reference-ground potential node preferably corresponds to the neutral conductor or N conductor. The first potential node preferably corresponds to the phase or the L conductor.

An RC element is coupled from at least one potential node between the surge arresters to the reference-ground potential node. The RC element has a resistor connected in parallel and a capacitor. The arrangement thus has at least one RC element, but preferably has a plurality of RC elements. The arrangement can have, for example, two, three, four, five or ten RC elements. The respective RC element is coupled directly and, in particular, without further interconnected electronic components to the reference-ground potential node. The respective RC element is connected in parallel with in each case at least one surge arrester.

The capacitor may be discharged by the resistor within a short period of time according to the surge current by the resistor connected in parallel with said capacitor. The response surge voltage remains constantly low. Furthermore, the response surge voltage is lower with the capacitor-resistor combination, even in the case of the first response, than without a resistor. An arrangement having a constantly lower response surge voltage is thus provided.

According to an embodiment, an RC element having a resistor connected in parallel and a capacitor is in each case coupled from a potential node between two adjacent surge arresters to the reference-ground potential node. If the arrangement has a number N of surge arresters, N−1 RC elements are provided. The respective resistor is provided to discharge the associated capacitor and hence to keep the response surge voltage low.

According to an embodiment, the arrangement has groups of surge arresters. A group can have two, three or more surge arresters. The arrangement can have two, three or more groups. An RC element having a resistor connected in parallel and a capacitor is in each case coupled from a potential node between the individual groups to the reference-ground potential node.

According to an embodiment, an RC element is associated with each surge arrester. If the arrangement has a number N of surge arresters, N RC elements are also provided in this case. This can further increase the turn-on response of the arrangement.

According to an embodiment, the time constant T of the RC element, in particular of the respective RC element, is less than or equal to 1 ms. This can ensure rapid discharge of the capacitor and keep the response surge voltage low.

According to an embodiment, the capacitance C of the capacitor, in particular of the respective capacitor, is between 1 nF and 40 nF, wherein the respective end points are included (1 nF≤C≤40 nF). In this case, the higher the capacitance, the higher the turn-on time (the reaction time) of the surge arrester. The response surge voltage decreases.

According to an embodiment, the rated value of the resistor, in particular of the respective resistor, is between 1 kΩ and 100 kΩ, wherein the respective end points are included (1 kΩ≤R≤100 kΩ). In this case, the lower the resistance value, the longer it takes to charge the capacitor during the current pulse. The turn-on time increases.

According to one aspect, the use of an arrangement in an electronic device or in an electrical grid is described. The arrangement preferably corresponds to the arrangement described above. All of the features that have been described in connection with the arrangement also apply, in particular, to the use of the arrangement.

For example, the arrangement can be used in a telecommunications device, for example, a telecommunications network. However, said arrangement is not restricted to telecommunications networks and can also be used in any other electrical circuit in which voltages have to be conducted away by means of a surge arrester.

What has been described above will be explained in greater detail in the following text with reference to embodiments.

### BRIEF DESCRIPTION OF THE DRAWINGS

The drawings described below are not to be seen as true to scale but instead the individual dimensions of the illustrations may be illustrated in an enlarged, reduced or even distorted manner.

In the drawings:

FIG. 1a shows a circuit diagram for an arrangement for arresting overvoltages in accordance with the prior art;

FIG. 1b shows a perspective view of an arrangement for arresting overvoltages in accordance with the prior art;

FIG. 2a shows a circuit diagram for an arrangement for arresting overvoltages; and

FIG. 2b shows a perspective view of an arrangement for arresting overvoltages.

### DETAILED DESCRIPTION OF ILLUSTRATIVE EMBODIMENTS

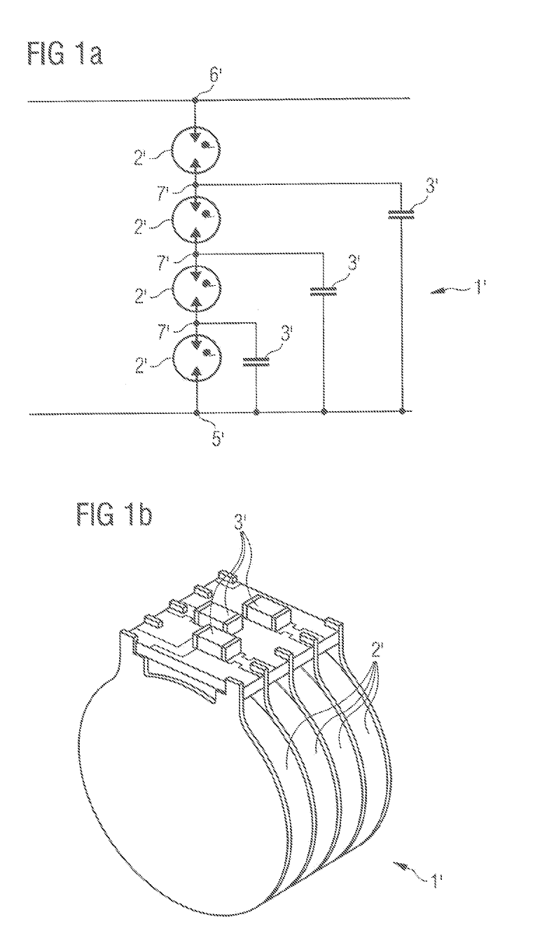

FIG. 1a shows a circuit diagram for an arrangement 1′ for arresting overvoltages in accordance with the prior art. FIG. 1b shows a perspective view of the arrangement 1′ for arresting overvoltages in accordance with the prior art.

The arrangement 1′ has a plurality of gas-filled surge arresters, gas arresters 2′ for short. The gas arresters 2′ are connected in series. The gas arresters 2′ are stacked one above the other in the arrangement 1′, as can be seen from FIG. 1b. The arrangement 1′ is a so-called multiple stack arrester. A DC voltage can be applied to the series circuit of the gas arresters 2′ via a first potential node 6′ (L conductor) and a reference-ground potential node 5′ (neutral conductor).

After the current surge has subsided, the so-called follow current flows from the grid, between L and N conductors 6′,5′. It is necessary to stop or even prevent said follow current as quickly as possible. To achieve this, multiple stack arresters are used. The arc voltage of the individual gas arresters 2′ are thus added. The follow current is stopped. This produces the negative side effect that the response surge voltage increases with the number of individual gas arresters 2′ (paths) in the stack. The limiting voltage “protection level” of the multiple stack arrester becomes too high. For this reason, capacitors 3′ are connected in parallel with the individual gas arresters 2′. In particular, a capacitor 3′ connected in parallel is in each case coupled from a potential node 7′ between the individual gas arresters 2′ to the reference-ground potential node 5′.

The capacitors 3′ make the faster turn-on response of the gas arresters 2′ in the stack possible.

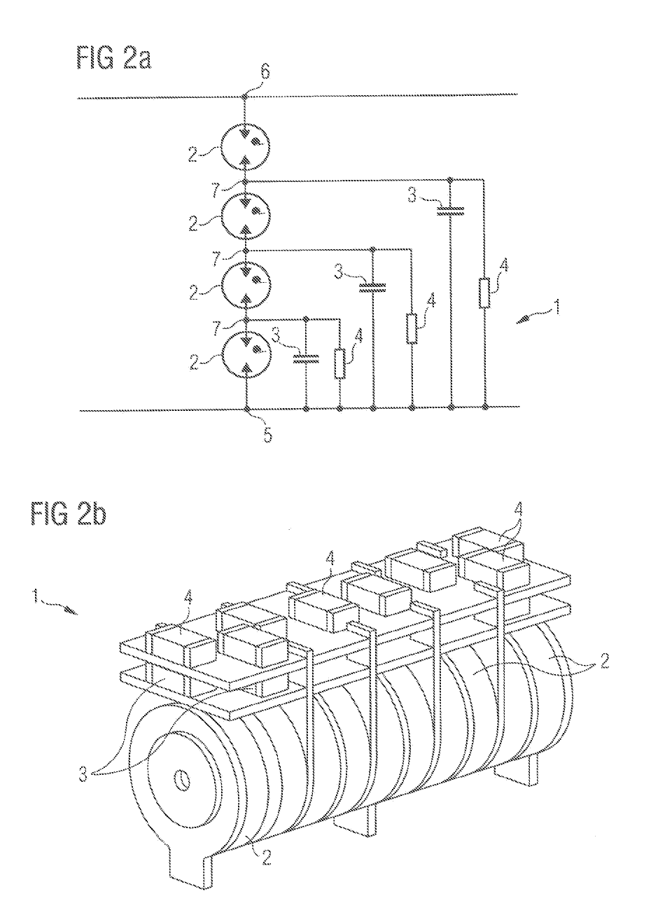

After the multiple stack arrester has extinguished the follow current and has returned back to the high-impedance state, the capacitors 3′, however, remain partially charged, which minimizes the effect of the capacitor 3′ in the case of the next overvoltage. To prevent this, in accordance with the invention, a resistor is used in parallel with the capacitor, as can be seen from FIGS. 2a and 2b.

FIG. 2a shows a circuit diagram for an arrangement 1 for arresting overvoltages.

FIG. 2b further shows a perspective view of an arrangement 1 for arresting overvoltages.

The arrangement 1 has a plurality of gas-filled surge arresters, gas arresters for short, 2. According to this embodiment, the arrangement 1 has between four and ten gas arresters 2. However, other numbers N of gas arresters 2, for example, 15, 20 or 30 gas arresters 2, are also conceivable. The number of gas arresters 2 shown is consequently to be seen purely as exemplary.

The gas arresters 2 are stacked one above the other (FIG. 2b). The gas arresters 2 are connected in series. In particular, the gas arresters 2 are in series between a first potential node 6 (L conductor) and a reference-ground potential node 5 (neutral conductor).

A capacitor 3 is connected in parallel with at least some of the gas arresters 2. A resistor 4 is connected in parallel with the respective capacitor 3. According to the embodiment shown in FIG. 2a, an RC element having a resistor 4 connected in parallel and a capacitor 3 is in each case coupled from a potential node 7 between the individual gas arresters 2 to the reference-ground potential node 5. If the arrangement 1 thus has N gas arresters 2, in accordance with the embodiment shown, N−1 RC elements are provided in the arrangement 1.

As an alternative thereto, in a further embodiment, the number of gas arresters 2 may, however, also correspond to the number of RC elements in the arrangement 1 (not explicitly illustrated). Given N gas arresters 2, there are therefore N RC elements too.

As an alternative thereto, in a further embodiment (not explicitly illustrated), an RC element may be associated with a group of gas arresters 2 connected in series, for exaample, a group of two, three, four or five gas arresters 2. In this case, the arrangement i can have a plurality of groups, for example, two or three groups, of gas arresters 2. An RC element having a resistor 4 connected in parallel and a capacitor 3 is then in each case coupled from a potential node between the individual groups to the reference-ground potential node 5.

The arrangement i is designed in such a way that the respective capacitor 3 is discharged via the respective resistor 4, and the response surge voltage is thus kept low. The respective capacitor 3 is discharged by the resistor 4 within a few milliseconds (ms) after the surge current. The response surge voltage consequently remains constantly low. Furthermore, the response surge voltage is lower with the capacitor-resistor combination, even in the case of the first response, than without the resistor 4.

The respective RC element is coupled directly and, in particular, without further interconnected electronic components to the reference-ground potential node 5. The respective RC element is preferably selected in such a way that the time constant τ=R·C is in the millisecond range, wherein R specifies the rated value of the resistor 4 and C specifies the capacitance of the capacitor 3. Preferably, τ≤1 ms holds true, for example, 0.9 ms or 0.5 ms.

The capacitors 3 have a capacitance C in the range between 1 nF and 40 nF, wherein the respective end points of the range are included. The capacitance C of the respective capacitor 3 is preferably less than 20 nF, for example, 15 nF or 10 nF. In this case, with a higher capacitance C, the turn-on time (the reaction time) of the respective gas arrester 2 increases. The response surge voltage decreases.

The resistors 4 have a rated value R in the range between 1 kΩ and loo kΩ, wherein the respective end points of the range are included. The rated value R of the respective resistor 4 is preferably less than 100 kΩ, preferably less than 90 kΩ, for example, 85 kΩ or 82 kΩ. The lower the resistance value, the longer it takes to charge the capacitor 3 during the current pulse. The turn-on time increases.

The capacitor-resistor combination of 10 nF and 82 kΩ has been found to be particularly advantageous.

By using the resistor 4, the number of individual gas arresters 2 in the arrangement 1 can be increased and the extinguishing properties of the arrangement 1 can be improved without the response voltage becoming too high.

The description of the subjects specified here is not limited to the individual specific embodiments. Rather, the features of the individual embodiments—insofar as it makes technical sense—can be combined with one another arbitrarily.

1-9. (canceled)

10. An arrangement for arresting overvoltages comprising:
a series circuit comprising a plurality of gas-filled surge arresters between a first potential node and a reference-ground potential node; and
at least one RC element comprising a capacitor and a resistor connected in parallel, the RC element being coupled from at least one potential node between the surge arresters directly to the reference-ground potential node.

11. The arrangement according to claim 10, wherein the at least one RC element comprises a plurality of RC elements, and wherein each RC element is coupled from a potential node between two adjacent surge arresters directly to the reference-ground potential node.

12. The arrangement according to claim 10,
wherein the arrangement comprises groups of surge arresters,
wherein the at least one RC element comprises a plurality of RC elements, and
wherein each RC element is coupled from a potential node between the individual groups directly to the reference-ground potential node.

13. The arrangement according claim 10, wherein a time constant τ of the RC element is less than or equal to 1 ms.

14. The arrangement according to claim 10, wherein the capacitance C of the capacitor is greater than or equal to 1 nF and less than or equal to 40 nF.

15. The arrangement according to claim 10, wherein a rated value of the resistor is greater than or equal to 1 kΩ and less than or equal to 100 kΩ.

16. The arrangement according to claim 10, wherein the arrangement is placed in an electronic device.

17. The arrangement according to claim 10, wherein the arrangement is placed in an electrical grid.
